(19) United States
(12) Patent Application Publication
(10) Pub. No.: US 2023/0283693 A1
(43) Pub. Date: Sep. 7, 2023

(54) METHOD AND SYSTEM FOR OPTIMIZING CONTENT REMOVAL FROM CONTENT STORE IN NDN

(71) Applicant: ELECTRONICS AND TELECOMMUNICATIONS RESEARCH INSTITUTE, Daejeon (KR)

(72) Inventors: Yong Yoon SHIN, Daejeon (KR); Sae Hyong PARK, Daejeon (KR); Nam Seok KO, Daejeon (KR)

(73) Assignee: ELECTRONICS AND TELECOMMUNICATIONS RESEARCH INSTITUTE, Daejeon (KR)

(21) Appl. No.: 18/098,807

(22) Filed: Jan. 19, 2023

(30) Foreign Application Priority Data
Mar. 3, 2022 (KR) 10-2022-0027680

(51) Int. Cl. H04L 67/63; H04L 67/568

(52) U.S. Cl. CPC H04L 67/63; H04L 67/568

(57) ABSTRACT

Disclosed herein a method and system for optimizing content removal from content store in NDN. The method includes: search the content store when receiving a request interest packet from a consumer; generating an optimization table when receiving the request interest packet; receiving first data corresponding to the request interest packet from a producer; storing the first data in the content store; setting an entry hit rate and a threshold; and deleting the stored first data based on the set entry hit rate and the set threshold.

### CROSS REFERENCE TO RELATED APPLICATION

The present application claims priority to Korean Patent Application No. 10-2022-0027680 filed Mar. 3, 2022, the entire contents of which is incorporated herein for all purposes by this reference.

### BACKGROUND OF THE INVENTION

### 1. Field of the Invention

The present disclosure relates to a method and system for optimizing content removal and, more particularly, to a method and system for optimizing content removal from a content store in named data networking (NDN).

### 2. Description of the Related Art

Named data networking (hereinafter referred to as NDN) is used in the same concept as content centric networking (hereinafter referred to as CCN) and is one of the implementation examples for future networks discussed in information centric networking (hereinafter referred to as ICN).

In NDN, packets are transmitted based on the layered unique name of data, and a data temporary storage function is implemented in a node to ensure efficient data transmission. Basically, since network efficiency is increased using data stored in the node, the location of the node that temporarily stores the data makes a big impact on overall network performance.

Basic NDN is increasing network efficiency by prioritizing a strategy of storing as much data as possible in all nodes on a path.

However, a conventional method of storing as much content as possible in a CS of every node located in the network requires a large amount of storage space, and the temporarily stored data is concentrated in a central network, or data that is no longer used in the network is accumulated. Therefore, the storage space of the node was insufficient and overall network efficiency was gradually decreased, causing a user to feel uncomfortable.

### SUMMARY OF THE INVENTION

An object of the present disclosure is to provide a method and system for optimizing content removal, which is capable of improving efficiency of an entire network and CS by removing temporarily stored data of a node with a low usage rate without removing temporarily stored data of a node with a high usage rate in removing temporarily stored data from the network.

The technical objects of the present disclosure are not limited to the above-mentioned technical objects, and other technical objects that are not mentioned will be clearly understood by those skilled in the art through the following descriptions.

According to the present disclosure, there is provided a method and system for optimizing content removal from content store in named data networking (NDN), the method comprising: search the content store when receiving a request interest packet from a consumer; generating an optimization table when receiving the request interest packet; receiving first data corresponding to the request interest packet from a producer; storing the first data in the content store; setting an entry hit rate and a threshold; and deleting the stored first data based on the set entry hit rate and the set threshold.

According to the embodiment of the present disclosure in the method, the method may further comprise adding a PIT entry for the request interest packet when receiving the request interest packet from a consumer.

According to the embodiment of the present disclosure in the method, the generating the optimization table may comprise setting at least one of a search count or a hit count according to a search and matching result of the content store; and generating the optimization table based on at least one of the set search count or the hit count.

According to the embodiment of the present disclosure in the method, the search count and the hit count may be accumulated according to the number of times the request interest packet is received.

According to the embodiment of the present disclosure in the method, the hit count may have a linear relationship with a consumer's request.

According to the embodiment of the present disclosure in the method, the setting the entry hit rate and the threshold may further comprise setting the entry hit rate to a value obtained by dividing the hit count by the search count.

According to the embodiment of the present disclosure in the method, the setting the entry hit rate and the threshold may further comprise setting the threshold to an average of the entry hit rate.

According to the embodiment of the present disclosure in the method, the deleting the stored first data based on the set entry hit rate and the set threshold may further comprise storing the data when the set entry hit rate exceeds the set threshold.

According to the embodiment of the present disclosure in the method, the deleting the stored first data based on the set entry hit rate and the set threshold may further comprise deleting the first data when the set entry hit rate is equal to or less than the set threshold.

According to the embodiment of the present disclosure in the method, the searching the content store may further comprise searching the content store using a skip-list.

According to another embodiment of the present disclosure, there is provided a device for optimizing content removal from a content store in named data networking (NDN), the device comprising; a content store configured to temporarily store data; and a content optimization management unit. The content optimization management unit configured to: search the content store when receiving a request interest packet from a consumer; generate an optimization table when receiving the request interest packet; receive first data corresponding to the request interest packet from a producer; store the first data in the content store; set an entry hit rate and a threshold; and delete the stored first data based on the set entry hit rate and the set threshold.

According to the embodiment of the present disclosure in the device, the content optimization management unit may add a PIT entry for the request interest packet when receiving the request interest packet from a consumer.

According to the embodiment of the present disclosure in the device, the content optimization management unit may be configured to: set at least one of a search count or a hit count according to a search and matching result of the content store; and generate the optimization table based on at least one of the set search count or the hit count.

According to the embodiment of the present disclosure in the device, the search count and the hit count may be accumulated according to the number of times the request interest packet is received.

According to the embodiment of the present disclosure in the device, the hit count may have a linear relationship with a consumer's request.

According to the embodiment of the present disclosure in the device, the content optimization management unit may set the entry hit rate to a value obtained by dividing the hit count by the search count.

According to the embodiment of the present disclosure in the device, the content optimization management unit may set the threshold to an average of the entry hit rate.

According to the embodiment of the present disclosure in the device, the content optimization management unit may store the data when the set entry hit rate exceeds the set threshold.

According to the embodiment of the present disclosure in the device, the content optimization management unit may delete the first data when the set entry hit rate is equal to or less than the set threshold.

According to another embodiment of the present disclosure, there is provided a device for optimizing content removal from a content store in named data networking (NDN), the device comprising; a memory configured to temporarily store data; and a processor. The processor configured to: search the content store when receiving a request interest packet from a consumer; generate an optimization table when receiving the request interest packet; receive first data corresponding to the request interest packet from a producer; store the first data in the content store; set an entry hit rate and a threshold; and delete the stored first data based on the set entry hit rate and the set threshold.

The features briefly summarized above for this disclosure are only exemplary aspects of the detailed description of the disclosure which follow, and are not intended to limit the scope of the disclosure.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a diagram illustrating an NDN node content accumulation according to an embodiment of the present disclosure;

FIG. 2 is a diagram illustrating a block structure of a node according to an embodiment of the present disclosure;

FIG. 3 is a diagram illustrating a CS entry count table structure according to an embodiment of the present disclosure;

FIG. 4 is a diagram illustrating a CS optimization structure according to an embodiment of the present disclosure;

FIG. 5 is a diagram illustrating a CS optimization process procedure according to an embodiment of the present disclosure;

FIG. 6 is a diagram illustrating a CS content optimization and CS content removal procedure according to an embodiment of the present disclosure;

FIG. 7 is a diagram illustrating a skip-list configuration according to an embodiment of the present disclosure;

FIG. 8 is a diagram illustrating a skip-list search and a CS search according to an embodiment of the present disclosure;

FIG. 9 is a diagram illustrating skip-list deletion and CS data deletion according to an embodiment of the present disclosure;

FIG. 10 is a diagram illustrating CS content optimization and deletion list generation according to an embodiment of the present disclosure;

FIG. 11 is a diagram illustrating CS content optimization and deletion list generation according to an embodiment of the present disclosure;

FIG. 12 is a flowchart of a content removal optimization method according to an embodiment of the present disclosure; and

FIG. 13 is a diagram illustrating a configuration of a content removal optimization device according to an embodiment of the present disclosure.

### DESCRIPTION OF THE PREFERRED EMBODIMENTS

Hereinafter, exemplary embodiments of the present disclosure will be described in detail with reference to the accompanying drawings so that those skilled in the art may easily implement the present disclosure. However, the present disclosure may be implemented in various different ways, and is not limited to the embodiments described therein.

In describing exemplary embodiments of the present disclosure, well-known functions or constructions will not be described in detail since they may unnecessarily obscure the understanding of the present disclosure. The same constituent elements in the drawings are denoted by the same reference numerals, and a repeated description of the same elements will be omitted.

In the present disclosure, when an element is simply referred to as being “connected to”, “coupled to” or “linked to” another element, this may mean that an element is “directly connected to”, “directly coupled to” or “directly linked to” another element or is connected to, coupled to or linked to another element with the other element intervening therebetween. In addition, when an element “includes” or “has” another element, this means that one element may further include another element without excluding another component unless specifically stated otherwise.

In the present disclosure, the terms first, second, etc. are only used to distinguish one element from another and do not limit the order or the degree of importance between the elements unless specifically mentioned. Accordingly, a first element in an embodiment could be termed a second element in another embodiment, and, similarly, a second element in an embodiment could be termed a first element in another embodiment, without departing from the scope of the present disclosure.

In the present disclosure, elements that are distinguished from each other are for clearly describing each feature, and do not necessarily mean that the elements are separated. That is, a plurality of elements may be integrated in one hardware or software unit, or one element may be distributed and formed in a plurality of hardware or software units. Therefore, even if not mentioned otherwise, such integrated or distributed embodiments are included in the scope of the present disclosure.

In the present disclosure, elements described in various embodiments do not necessarily mean essential elements, and some of them may be optional elements. Therefore, an embodiment composed of a subset of elements described in an embodiment is also included in the scope of the present disclosure. In addition, embodiments including other elements in addition to the elements described in the various embodiments are also included in the scope of the present disclosure.

The advantages and features of the present invention and the way of attaining them will become apparent with reference to embodiments described below in detail in conjunction with the accompanying drawings. Embodiments, however, may be embodied in many different forms and should not be constructed as being limited to example embodiments set forth herein. Rather, these embodiments are provided so that this disclosure will be complete and will fully convey the scope of the invention to those skilled in the art.

In the present disclosure, each of phrases such as “A or B”, “at least one of A and B”, “at least one of A or B”, “A, B or C”, “at least one of A, B and C”, mat Each of the phrases such as “at least one of A, B or C” and “at least one of A, B, C or combination thereof” may include any one or all possible combinations of the items listed together in the corresponding one of the phrases.

In the present disclosure, expressions of location relations used in the present specification such as “upper”, “lower”, “left” and “right” are employed for the convenience of explanation, and in case drawings illustrated in the present specification are inversed, the location relations described in the specification may be inversely understood.

Hereinafter, embodiments of the present disclosure will be described with reference to the accompanying drawings.

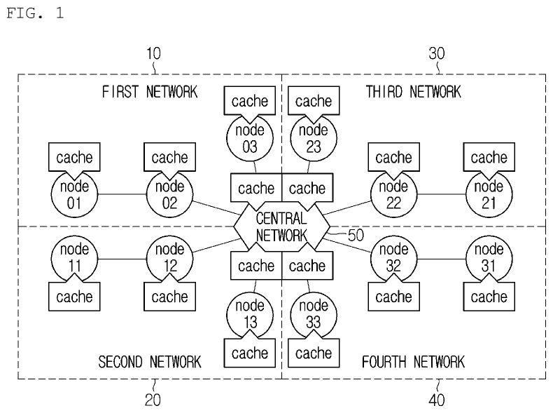

FIG. 1 is a diagram illustrating an NDN node content accumulation according to an embodiment of the present disclosure.

As shown in FIG. 1, a first network 10, a second network 20, a third network 30, and a fourth network 40 are connected through a central network 50.

Data generated in each domain is temporarily stored in a node according to a user's request.

Each domain data is highly likely to be consumed in the same domain.

Since the central network 50 is connected to all domains, all data generated in the domain is highly likely to be temporarily stored.

Temporarily stored data in the CS of each node is removed according to the policy.

FIFO (First-In-First-Out) refers to replacement of the oldest data.

Least-Recently-Used (LRU) refers to replacement of data that has not been used for the longest time.

Least-frequently-used (LFU) refers to replacement of data with the smallest reference count.

The current content management method of NDN described above uses a method of unconditionally storing content in all NDN nodes up to a storage limit and removing content according to the three policies described above. However, since the characteristics of the policies are different, it is very difficult to select an appropriate temporarily stored data deletion policy. In particular, in the case of LRU and LFU, data temporarily stored in all networks is highly likely to be deleted at the same time.

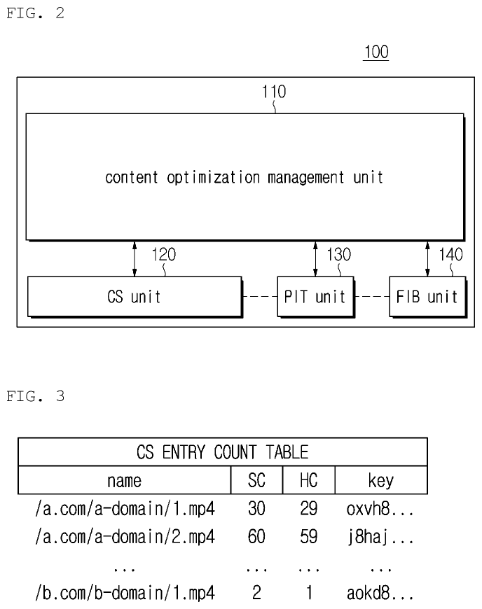

FIG. 2 is a diagram illustrating a block structure of a node according to an embodiment of the present disclosure.

As shown in FIG. 2, the entire block is described, but may be configured autonomously if necessary.

According to an embodiment of the present disclosure, a node 100 may be a content removal optimization device 100.

The content removal optimization device 100 includes a content optimization management unit 110, a content store (CS) unit 120, a pending interest table (PIT) unit 130 and a forwarding information base (FIB) unit 140.

NDN finds temporarily stored data through CS search when receiving an interest, and returns the data when there is a match entry, providing fast data deliver. When there are many entries in the CS unit 120, all entries need to be searched, and, when there is no search result, it is transmitted to a next node.

A response to the interest is provided as data, and the data generated from a data producer is transmitted in the reverse direction of interest progress. Each node, which has received a data packet, forwards the data to a previous node and stores the received data packet in an internal CS.

The content optimization management unit 110 generates a consumer search and matching result for data temporarily stored in the node as a search count (SC) and a hit count (HC) and manages them as a table.

The content optimization management unit 110 generates a cache hit rate (CHR) for each request based on information on the table, and generates a hit level based on the CHR of each request. After that, the CS entry is adjusted by comparing the CHR and the HL.

The CS unit 120 temporarily stores the received data.

The PIT unit 130 manages interest and interface information for processing the response to the interest.

The FIB unit 140 determines a forwarding interface (FACE) based on a data name included in the interest.

The content optimization management unit 110 searches the CS unit 120 upon receiving a request interest packet from a consumer, generates an optimization table upon receiving the request interest packet, receives first data corresponding to the request interest packet from a producer, stores the first data in the CS unit 120, sets an entry hit rate and a threshold, and deletes the stored first data based on the set entry hit rate and the set threshold.

The content optimization management unit 110 adds a PIT entry for the request interest packet, upon receiving the request interest packet from the consumer.

The content optimization management unit 110 sets at least one of a search count or a hit count according to a search and matching result of the CS unit 120, and generates the optimization table based on at least one of the set search count or the hit count.

Here, the search count and the hit count are accumulated according to the number of times the request interest packet is received.

The hit count has a linear relationship with the consumer's request.

The content optimization management unit 110 sets the entry hit rate to a value obtained by dividing the hit count by the search count.

The content optimization management unit 110 sets the threshold to an average of the entry hit rate.

The content optimization management unit 110 stores the data when the set entry hit rate exceeds the set threshold.

The content optimization management unit 110 deletes the first data when the set entry hit rate is equal to or less than the set threshold.

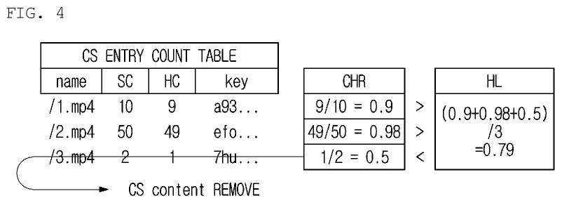

FIG. 3 is a diagram illustrating a CS entry count table structure according to an embodiment of the present disclosure.

As shown in FIG. 3, the CS entry count table is generated.

The content optimization management unit 110 manages a search and matching table through CS search.

Here, the hit count means the cumulative number of CS entry matching.

The search count means the cumulative number of CS entry search.

The key (key for skiplist) means a CS index value (hash).

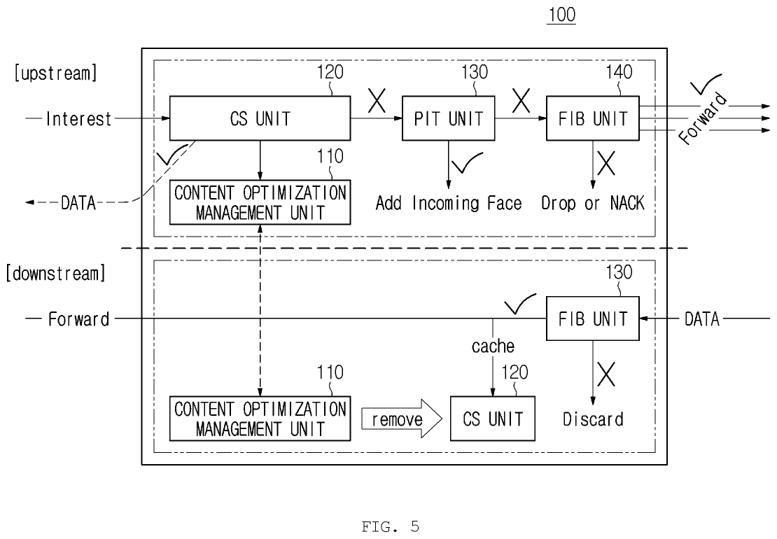

FIG. 4 is a diagram illustrating a CS optimization structure according to an embodiment of the present disclosure.

Management of the hit rate of each CS entry will be described with reference to FIG. 4.

First, a hit rate is generated based on a CS search and matching table.

The CS entry hit rate refers to a value obtained by dividing the hit count by the search count.

The CS entry hit rate is expressed as follows. CHR (Cache Hit Rate)=HC (Hit Count)/SC (Search Count)

In addition, the CS entry hit rate has a value of 0 to 1.

CS hit rate average management will be described.

The hit level refers to a Hit Level (HL), and the hit level is basically set to a CHR average of each content temporarily stored in the node.

It is expressed as shown in the following equation.

HL(HitLevel)=(ΣCHR)/(ΣCS entry)

where, ΣCHR refers to a sum of cache hit rate of each CS entry. ΣCS entry refers to the number of CS entries.

In addition, the hit level may be arbitrarily set by an administrator. This is to prepare for occurrence of an abnormal situation.

For example, for a first file, the cache hit rate is 0.9. For a second file, the cache hit rate is 0.98. For a third file, the cache hit rate is 0.5. The hit level is (0.9+0.98+0.5)/3=0.79.

Next, optimization of the content temporarily stored in the CS through mutual comparison of the CS hit rates will be described.

The CS stored in multiple nodes is adjusted by setting a threshold for the hit count.

When the cache hit rate exceeds the hit level, temporary data is stored in the content store.

[symbol]

(CacheHitRate)>3 [symbol] (HitLevel)=Store

When the cache hit rate is equal to or less than the hit level, the temporary data is removed from the content store.

[symbol]

(CacheHitRate)≤ [symbol] (HitLevel)=Remove

Next, provision of a secondary index for constructing a skip-list will be described.

Here, the key refers to an index value composed of a hash.

The key refers to a point that points to the temporary data stored in the CS.

Next, a preliminary preparation step will be described.

A network is composed of multiple NDN nodes.

In each NDN node, an interface (FACE) is set based on NFD.

The consumer sends an interest for desired data.

In all nodes, the content optimization management unit 110 is configured.

Data for the interest is stored in the CS unit 120 of each node.

The content optimization management unit 110 and the CS unit 120 are linked internally.

FIG. 5 is a diagram illustrating a CS optimization process procedure according to an embodiment of the present disclosure.

Referring to FIG. 5, a consumer 10 requests data through an interest and shall know a data name (S510).

Here, each node adds a PIT entry for the received interest.

The node, which has received the request interest, searches the CS unit 120 (S520).

Here, if there is matching data in the CS entry, data is sent as a response.

The content optimization management unit 110 of each node configures a table for optimization upon receiving the interest (S530).

The search count and the hit count are set according to the CS search and matching result of the node. Here, the search count and the hit count are accumulated. The set value is managed as a table.

A producer 20 provides data on the interest (S540).

Here, data is stored in the CS unit of each node.

The content optimization management unit 110 of each node manages the entry hit rate (S550).

The search count and the hit count stored in the CS content table are used.

The cache hit rate is defined as a value obtained by dividing the hit count by the search count.

For example,

$$( CacheHitRate ) = \frac{( HitCount )}{( SearchCount )}$$

The cache hit rates for popular data and a network with many consumers are relatively high.

The content optimization management unit 110 of each node sets a threshold (S560).

Here, a cache hit rate for each content is generated.

A sum of cache hit rates of the entire node CS content is defined as Σ [symbol] (CacheHitRate).

The number of node CS content entries is defined as ΣCSentry.

The threshold is an average of cache hit rate.

$$( HitLevel ) = \frac{\sum }{\sum entry}$$

Also, the threshold may be set to a special value by the administrator.

The content optimization management unit 110 of each node deletes content through comparison with the threshold (S570).

The cache hit rate for the data of a node for which a consumer's request is reduced is reduced.

A difference in cache hit rate gradually occurs for each data temporarily stored in the node.

For example, when the cache hit rate exceeds the hit level, the temporarily stored data is stored.

[symbol]

(CacheHitRate)> [symbol] (HitLevel)=Store

When the cache hit rate is equal to or less than the hit level, the temporarily stored data is deleted.

[symbol]

(CacheHitRate)≤ [symbol] (HitLevel)=Remove

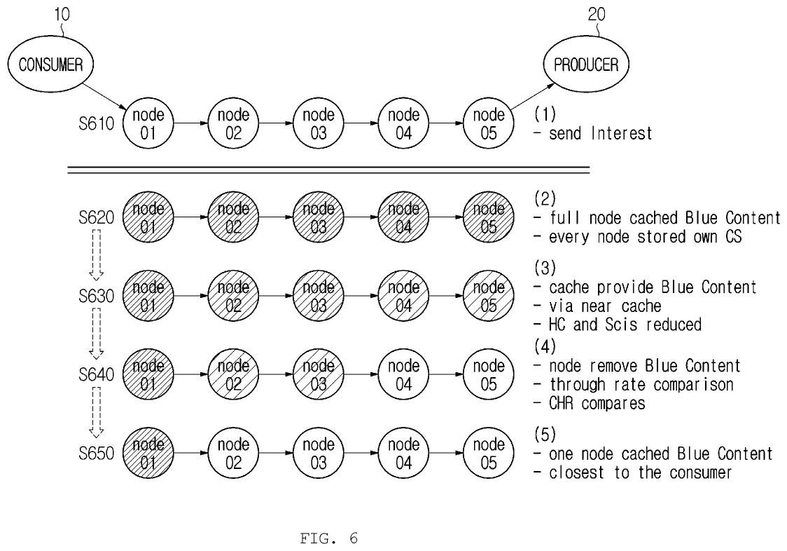

FIG. 6 is a diagram illustrating a CS content optimization and CS content removal procedure according to an embodiment of the present disclosure.

First, an interest for a data request is received from the consumer 10 (S610).

It is transmitted based on a data name requested by the consumer 10.

Each node adds the name requested by the consumer to the PIT.

Here, the PIT is composed of FACE information for interest.

When the interest is the same, the FACE is configured to be added.

The data is temporarily stored in the CS of every node that transmits a data response to the consumer (S620).

The node, which has received the data response, checks PIT information.

The data is transmitted as the FACE of PIT information.

At the same time, the data is stored in its own CS.

A response to the same interest generated thereafter is sent using the temporarily stored data (S630).

Fast processing of the same interest of the same or different consumers is provided.

Upon receiving the interest, first, the CS unit 120 is searched.

The searched information is accumulated to generate a search count.

When the number of requests from the consumer 10 decreases, the cumulative search count decreases compared to other CS entries.

Matching information for search is accumulated to generate a hit count.

When the number of requests from the consumer 10 decreases, the cumulative hit count decreases compared to other CS entries.

A cache hit rate is generated using information accumulated in the node.

The cache hit rate is a value obtained by dividing the hit count by the search count.

$$( CacheHitRate ) = \frac{( HitCount )}{( SearchCount )}$$

Each node removes temporary data that no longer needs temporary storage (S640).

A hit level is generated based on each cache hit rate of the node.

An overall average value is specified based on the cache hit rate for each CS entry.

A sum of the cache hit rate of each CS entry is divided by the number of CS entries being temporarily stored.

It is expressed as shown in the following equation

$$( HitLevel ) = \frac{\sum }{\sum entry}$$

where, the specified average value is set as the hit level.

The cache hit rate and the hit level are compared and removed.

For example, if the cache hit rate is equal to or less than the hit level, it is removed.

[symbol]

(CacheHitRate)≤ [symbol] (HitLevel)=Remove

The data is temporarily stored in the node closest to the consumer 10 (S650).

If there are many requests from consumers, the utilization rate of CS temporarily stored in the node increases.

The data is highly likely to be temporarily stored in nodes close to the consumer.

Gradually, it is temporarily stored only in the nodes around the consumer 10.

The entire network is optimized.

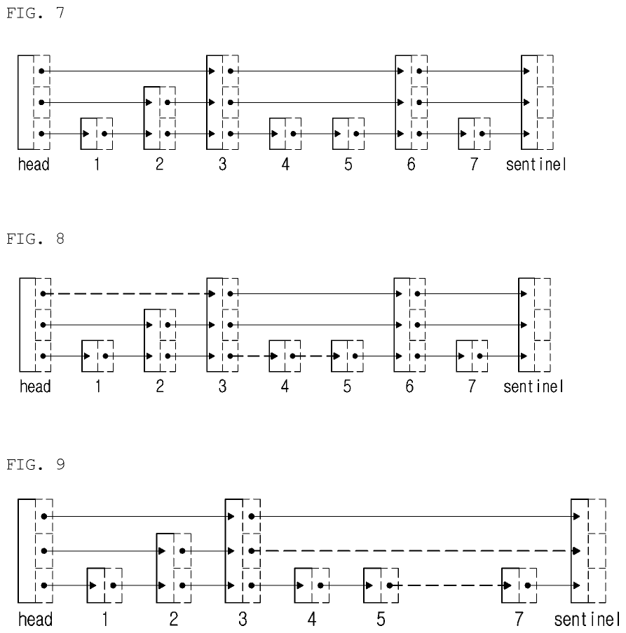

FIG. 7 is a diagram illustrating a skip-list configuration according to an embodiment of the present disclosure.

Skip-list is used as a method of searching for data temporarily stored in the CS in NDN. Skip-list is a commonly used algorithm and has the advantage of fast search, insertion, and deletion of data by improving the disadvantages of the existing linked list.

In the figure above, each number corresponds to an index of the temporarily stored data. The skip-list consists of a list between the head and the sentinel, and each list has a pointer layer called a level. That is, it is possible to quickly perform desired data search by using the pointer of the level without sequential search. In NDN, a skip-list is used to quickly support search of data temporarily stored in the CS, and the level is composed by using a value obtained by substituting actual data with hash as an index. When the skip-list is generated as described above, a path to find index 5 is as follows.

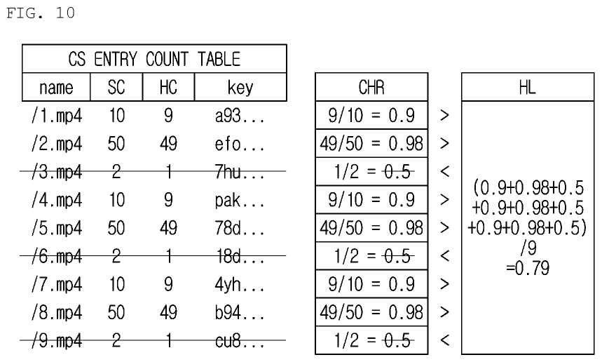

FIG. 8 is a diagram illustrating a skip-list search and a CS search according to an embodiment of the present disclosure.

When 5, which is the index of data, enters the head, it is searched from the first level and is moved along the pointer for list 3, the point for index 5 which has requested search among pointers 6 and 4 is determined through level search of list 3, and, since index 5 to be searched is less than pointer 6, it is moved to list 4 and is moved to the pointer that matches index 5 to be searched through level search of list 4.

In other words, search is possible through 3-time comparison. This method has an advantage even when deleting data, and the following procedure is performed.

FIG. 9 is a diagram illustrating skip-list deletion and CS data deletion according to an embodiment of the present disclosure.

In case of deleting list 6, index 6 is easily found, and the levels of list 3 and 5 with pointers for list 6 are modified to list 7 and sentinel, and list 6 is deleted.

The skip-list is a good algorithm, but it has some problems. The most common problem is that memory overhead occurs because pointer search is provided according to the level.

First, each list has a level and stores a pointer according to the level.

Next, the higher the level, the more pointers it has, which consumes the memory.

That is, as the number of data indices increases, the number of generated pointers increases, and, when multiple data is deleted at once, the number of pointer modifications increases. In general, the memory overhead problem is solved by implementing the secondary index, and memory overhead is solved by using the secondary index in which the pointer value is specified. This means that a separate method needs to be prepared directly to solve the memory overhead problem, and a different method may be used depending on the characteristics of the database.

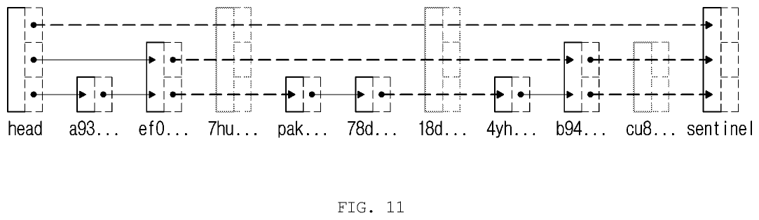

FIG. 10 is a diagram illustrating CS content optimization and deletion list generation according to an embodiment of the present disclosure.

The hit level generated through FIG. 6 may be used as a substitute for the auxiliary index presented as a method of solving the memory overhead problem of the skip-list. If there are 9 CS entries as shown in FIG. 10, the hit level is applied to the skip-list as follows.

Temporary data that no longer needs temporary storage is checked in each node.

Temporarily stored data increases over time, and data with a low cache hit rate also increases.

When the cache hit rate is relatively low, it means that temporary storage efficiency is lowered.

An appropriate hit level is calculated to check data with poor temporary storage efficiency. For example, it may be file 3, file 6, and file 9 of FIG. 10.

Each data list with poor temporary storage efficiency has a key corresponding to an index.

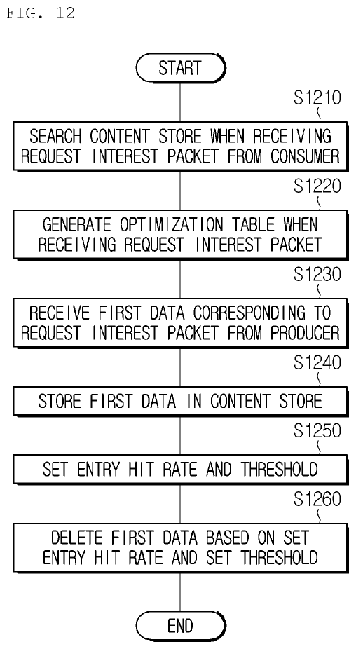

FIG. 11 is a diagram illustrating recalculation of a skip-list according to an embodiment of the present disclosure.

Referring to FIG. 11, pre-alignment of the points of the skip-list will be described.

Before the temporary data deletion, it responds based on the list to be deleted in advance.

The key for each item in the data list to be deleted is checked.

Pointer modification values for the level are computed at once.

Specifically, the key of each item is used as a secondary index.

A skip-list is constructed according to the calculated result.

For example, it is confirmed that the list to be subjected to pointer modification due to files 3, 6, and 9 to be deleted is files 2, 5, and 8.

The pointer is modified according to each level of file 2, file 5, and file 8. Next, the pointer modification is applied in batches.

As shown in FIG. 11, in the above procedure and embodiment, through node CS optimization according to the accumulation of data requests, it is possible to gradually and rationally adjust the CS, thereby increasing efficiency of the entire network. In addition, memory overhead may be minimized by basically providing a secondary index for the skip-list that is basically generated in NDN.

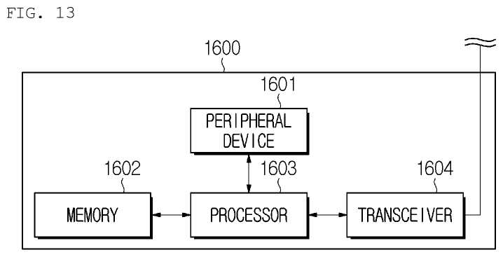

FIG. 12 is a flowchart of a content removal optimization method according to an embodiment of the present disclosure. The present disclosure is performed by the content removal optimization device 100.

As shown in FIG. 12, when a request interest packet is received from a consumer, a content store is searched (S1210).

When the request interest packet is received, an optimization table is generated (S1220).

First data corresponding to the request interest packet is received from a producer (S1230).

The first data is stored in the content store (S1240).

An entry hit rate and a threshold are set (S1250).

The stored first data is deleted based on the set entry hit rate and the set threshold (S1260).

FIG. 13 is a diagram illustrating a configuration of a content removal optimization device according to an embodiment of the present disclosure.

An embodiment of the content removal optimization device 100 may be a device 1600. Referring to FIG. 13, the device 1600 may include a memory 1602, a processor 1603, a transceiver 1604 and a peripheral device 1601. In addition, for example, the device 1600 may further include other components and is not limited to the above-described embodiment.

More specifically, the device 1600 of FIG. 13 may be an exemplary hardware/software architecture such as a content removal optimization device. In this case, as an example, the memory 1602 may be a non-removable memory or a removable memory. Also, as an example, the peripheral device 1601 may include a display, a GPS, or other peripheral devices, and is not limited to the above-described embodiment.

Also, as an example, the above-described device 1600 may include a communication circuit like the transceiver 1604, and may communicate with an external device based thereon.

Also, as an example, the processor 1603 may include at least one of a general-purpose processor, a digital signal processor (DSP), a DSP core, a controller, a microcontroller or one or more microprocessor associated with application specific integrated circuits (ASICs), field programmable gate array (FPGA) circuits, any other tangible integrated circuits (ICs) and a state machine. That is, it may be a hardware/software component for controlling the above-described device 1600.

At this time, the processor 1603 may execute computer-executable instructions stored in the memory 1602 to perform various essential functions of the content removal optimization device. For example, the processor 1603 may control at least one of signal coding, data processing, power control, input/output processing, or communication operations. Also, the processor 1603 may control a physical layer, a MAC layer, and an application layer. Also, as an example, the processor 1603 may perform authentication and security procedures at an access layer and/or an application layer, and is not limited to the above-described embodiment.

For example, the processor 1603 may communicate with other devices through the transceiver 1604. As an example, the processor 1603 may control the content removal optimization device to communicate with other devices over a network through execution of computer-executable instructions. That is, communication performed in the present disclosure may be controlled. For example, the transceiver 1604 may transmit an RF signal through an antenna, and may transmit the signal based on various communication networks.

In addition, as an example, MIMO technology, beamforming, etc. may be applied as the antenna technology, and is not limited to the embodiment. In addition, the signal transmitted and received through the transceiver 1604 may be modulated and demodulated and controlled by the processor 1603, and is not limited to the above-described embodiment.

According to an embodiment of the present disclosure, it is possible to improve efficiency of an entire network and CS by removing temporarily stored data of a node with a low usage rate without removing temporarily stored data of a node with a high usage rate in removing temporarily stored data from the network, thereby improving user convenience.

According to an embodiment of the present disclosure, it is possible to gradually and rationally adjust CS through node CS optimization according to accumulation of data requests, thereby increasing efficiency of the entire network.

According to an embodiment of the present disclosure, since a secondary index for a skip-list that is basically generated in NDN can be basically provided, memory overhead can be minimized.

It will be appreciated by persons skilled in the art that that the effects that can be achieved through the present disclosure are not limited to what has been particularly described hereinabove and other advantages of the present disclosure will be more clearly understood from the detailed description.

Other objects and advantages of the present disclosure may be understood by the following description, and will become more clearly understood by the embodiments of the present disclosure. Moreover, it will be readily apparent that the objects and advantages of the present disclosure may be realized by the means and combinations thereof described in the claims.

While the exemplary methods of the present disclosure described above are represented as a series of operations for clarity of description, it is not intended to limit the order in which the steps are performed, and the steps may be performed simultaneously or in different order as necessary. In order to implement the method according to the present disclosure, the described steps may further include other steps, may include remaining steps except for some of the steps, or may include other additional steps except for some of the steps.

The various embodiments of the present disclosure are not a list of all possible combinations and are intended to describe representative aspects of the present disclosure, and the matters described in the various embodiments may be applied independently or in combination of two or more.

In addition, various embodiments of the present disclosure may be implemented in hardware, firmware, software, or a combination thereof. In the case of implementing the present invention by hardware, the present disclosure can be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

The scope of the disclosure includes software or machine-executable commands (e.g., an operating system, an application, firmware, a program, etc.) for enabling operations according to the methods of various embodiments to be executed on an apparatus or a computer, a non-transitory computer-readable medium having such software or commands stored thereon and executable on the apparatus or the computer.

What is claimed is:

1. A method of optimizing content removal from a content store in named data networking (NDN), the method comprising;
search the content store when receiving a request interest packet from a consumer;
generating an optimization table when receiving the request interest packet;
receiving first data corresponding to the request interest packet from a producer;
storing the first data in the content store;
setting an entry hit rate and a threshold; and
deleting the stored first data based on the set entry hit rate and the set threshold.

2. The method of claim 1, further comprising adding a PIT entry for the request interest packet when receiving the request interest packet from a consumer.

3. The method of claim 1, wherein the generating the optimization table comprises:
setting at least one of a search count or a hit count according to a search and matching result of the content store; and
generating the optimization table based on at least one of the set search count or the hit count.

4. The method of claim 3, wherein the search count and the hit count are accumulated according to the number of times the request interest packet is received.

5. The method of claim 3, wherein the hit count has a linear relationship with a consumer's request.

6. The method of claim 1, wherein the setting the entry hit rate and the threshold further comprises setting the entry hit rate to a value obtained by dividing the hit count by the search count.

7. The method of claim 1, wherein the setting the entry hit rate and the threshold further comprises setting the threshold to an average of the entry hit rate.

8. The method of claim 1, wherein the deleting the stored first data based on the set entry hit rate and the set threshold further comprises storing the data when the set entry hit rate exceeds the set threshold.

9. The method of claim 1, wherein the deleting the stored first data based on the set entry hit rate and the set threshold further comprises deleting the first data when the set entry hit rate is equal to or less than the set threshold.

10. The method of claim 1, wherein the searching the content store further comprises searching the content store using a skip-list.

11. A device for optimizing content removal from a content store in named data networking (NDN), the device comprising;
a content store configured to temporarily store data; and
a content optimization management unit configured to:
search the content store when receiving a request interest packet from a consumer;
generate an optimization table when receiving the request interest packet;
receive first data corresponding to the request interest packet from a producer;
store the first data in the content store;
set an entry hit rate and a threshold; and
delete the stored first data based on the set entry hit rate and the set threshold.

12. The device of claim 11, wherein the content optimization management unit adds a PIT entry for the request interest packet when receiving the request interest packet from a consumer.

13. The device of claim 11, wherein the content optimization management unit is configured to:
set at least one of a search count or a hit count according to a search and matching result of the content store; and
generate the optimization table based on at least one of the set search count or the hit count.

14. The device of claim 13, wherein the search count and the hit count are accumulated according to the number of times the request interest packet is received.

15. The device of claim 13, wherein the hit count has a linear relationship with a consumer's request.

16. The device of claim 11, wherein the content optimization management unit sets the entry hit rate to a value obtained by dividing the hit count by the search count.

17. The device of claim 11, wherein the content optimization management unit sets the threshold to an average of the entry hit rate.

18. The device of claim 11, wherein the content optimization management unit stores the data when the set entry hit rate exceeds the set threshold.

19. The device of claim 11, wherein the content optimization management unit deletes the first data when the set entry hit rate is equal to or less than the set threshold.

20. A device for optimizing content removal from a content store in named data networking (NDN), the device comprising;
a memory configured to temporarily store data; and
a processor configured to:
search the content store when receiving a request interest packet from a consumer;
generate an optimization table when receiving the request interest packet;
receive first data corresponding to the request interest packet from a producer;
store the first data in the content store;
set an entry hit rate and a threshold; and
delete the stored first data based on the set entry hit rate and the set threshold.
